(19) United States
(12) Patent Application Publication
(10) Pub. No.: US 2004/0166919 A1
(43) Pub. Date: Aug. 26, 2004

(54) Electronic lottery ticket data structure, and method of generation, storage, and distribution of electronic lottery tickets

(76) Inventors: Gerald Duhamel, Drummondville (CA); Hugues Labrecque, Drummondville (CA); Laurence Nappert, Drummondville (CA)

Correspondence Address: LABTRONIX CONCEPT INC., C/O OGILVY RENAULT, 1981 MC GILL COLLEGE AVENUE, SUITE 1600, MONTREAL, QUEBEC, H3A 2Y3, CA

(21) Appl. No.: 10/686,531

(22) Filed: Oct. 16, 2003

Related U.S. Application Data
(60) Provisional application No. 60/418,369, filed on Oct. 16, 2002.
(60) Provisional application No. 60/494,571, filed on Aug. 13, 2003.

(51) Int. Cl. A63F 13/00

(52) U.S. Cl. 463/17

(57) ABSTRACT

The invention is a new structure of electronic lottery tickets wherein the quantity of information contains in one ticket may vary. Based on rules, each electronic lottery ticket contains information corresponding to a primary ticket plus either none, one or a plurality of subsequent tickets. Therefore, playing an electronic lottery ticket of this kind may involve a plurality of subsequent plays while requiring only a single ticket request from a ticket distribution system. Furthermore, via the use of this structure of electronic lottery tickets, an increase of the incentive of the game is available via free tickets, bonuses, changes in the outcome format, etc. Finally, the invention discloses a system suitable for the generation and distribution of a game using this new structure of electronic lottery tickets.

### CROSS-REFERENCE TO RELATED APPLICATIONS

This application claims priority of U.S. Provisional Patent Application serial No. 60/418,369, filed on Oct. 16, 2002 and entitled “Method of Generating and Distributing a Population of Lottery Tickets” and of U.S. Provisional Patent Application No. 60/494,571, filed on Aug. 13, 2003 entitled “Electronic Lottery Ticket Data Structure, and Method of Generation, Storage, and Distribution of Electronic Lottery Tickets”. The entire content of said provisional applications is incorporated herein by reference.

### FIELD OF THE INVENTION

The invention relates to a method and system to generate, store and distribute electronic lottery tickets. The invention particularly relates to a new data structure for these electronic lottery tickets.

### BACKGROUND OF THE INVENTION

Gaming industry in the United States is divided in three game categories: class I, II and III. Class I consists in entertainment only games; class II is mostly composed of bingo and lottery games; and class III includes all wagering games not included in above classes. The present invention particularly pertains to the class II games, and more precisely to lottery games.

Lottery games are well known in the gaming industry. Most popular formats for lottery game include paper-based tickets, said tickets being either scratch-off tickets, pull-tab tickets, or tickets bearing lottery numbers. Even today, most popular lottery games are played on a paper-based format.

Scratch-off format tickets consist in a paper ticket on which game information is concealed via an opaque substrate. Players remove the substrate to reveal the ticket information, consequently the ticket value. Pull-tab format tickets consist in folded or multi-layer tickets wherein ticket information cannot be revealed without pulling apart the ticket to reveal valuable information. Tickets bearing lottery numbers are either pre-printed or printed upon request, with the ticket values determined via comparison of their lottery numbers to a draw. This last type of lottery ticket offers a non-instant game, while the two others provide an instant one allowing the players to know instantly the ticket value after buying them.

With regard to instant-game lottery tickets, most of them bear information corresponding to the play of a multi-component game. For instance, a scratch-off lottery ticket may bear the information corresponding to a bingo and a lotto game. However, even if each ticket bears multi-game-like information, it is in fact two game representations involved in the play of a single ticket. Furthermore, all lottery tickets of the game contain the same quantity and type of information; in this case, the two same game representations with representation values summed up providing the ticket value.

Lottery tickets of another kind are electronically distributed lottery tickets (also known as electronic lottery tickets). Electronic lottery tickets are generated by a ticket generation program, stored on a ticket storage medium, inserted in a ticket distribution system, and distributed by said ticket distribution system to players on player terminals upon request. In an electronic format, an instant lottery game is provided with all requisite information for the play of a single electronic lottery ticket contained in each packet of information sent by the ticket distribution system to a player terminal. In consequence, the volume of information is constant from one ticket to another, like paper-based tickets.

U.S. Pat. No. 6,524,184 provides an alternative electronic ticket format for the play of an interactive lottery game. Lind et al. describe an interactive lottery game using a first-level population of electronic tickets and a plurality of second-level populations of electronic tickets, wherein correlation rules between the first- and second-level populations determines the level of interaction offered to the player. Accordingly, the invention of Lind et al. allows the play of an interactive lottery game similar to draw poker using a multi-population electronic-lottery-ticket format.

### OBJECTS OF THE INVENTION

Accordingly, an object of the invention is to provide a new electronic lottery ticket data structure allowing variation in the ticket information in order to provide variations of the game characteristics, additional incentives, etc. These variations of game characteristics and additional incentives can be additional graphic, additional animations, additional sounds, special event features, additional subsequent-ticket-play representations, etc.

Another object of the invention is to provide a new data structure for electronic lottery tickets wherein additional incentives can be added for the play of said tickets. Furthermore, said data structure should allow, within a single game, to provide tickets with incentives of different formats, either basic ticket-play representations, additional graphics, additional animations, additional sounds, special event features, additional subsequent-ticket-play representations, etc. Finally, the ticket structure should contain only pertinent ticket information in order to allow optimized communication of said tickets between the different systems pertaining to the play of such electronic lottery tickets.

Another object is to provide an optimized electronic-lottery-ticket data structure wherein only information pertaining to the play and representation of the requested electronic lottery ticket is transmitted by the ticket distribution system to the requesting player terminal. Accordingly, the use of said data structure decreases the quantity of information transmitted between the participating system-components and therefore lightens communications.

Another object is to provide a method of generating electronic lottery tickets based on said data structure. In consequence, electronic lottery tickets may contain information with regard to different incentives, may have different information volume from one another, etc and still be part of the same game.

Another object is to provide a system and method of distribution of said electronic lottery tickets. The system includes a ticket generation module, a ticket storage medium, a ticket distribution module, a communication module and at least one player terminal. The method in association to this system allows management and communication of the tickets in its most effective way in order to provide a secure, player-entertaining and communication-efficient electronic lottery game.

Finally, another object is to provide a method of playing and/or providing game representation of an electronic lottery ticket using said data structure. The player terminal on which a ticket representation is provided may be able to decode ticket information and modify game representation based on ticket information.

### SUMMARY OF THE INVENTION

In one of its embodiments, the present invention relates to a new electronic-lottery-ticket data structure wherein the volume and characteristic of the information contained in one electronic lottery ticket may vary from one ticket to another. According to said structure, each electronic lottery ticket contains base information (primary play-representation data), as well as optional additional pertinent information (such as primary-play representation-modification data, additional-play representation data, etc). Therefore, representation of an electronic lottery ticket of this kind on a player terminal may involve a single- or a multi-step ticket representation in response to a single ticket request of the requesting player terminal to the ticket distribution module.

The primary-play representation of an electronic lottery ticket and its subsequent play representations may keep the same display structure or may use different display structures. For instance, with an electronic lottery ticket containing additional-play representation data, a player terminal may provide a primary-play representation of the ticket in an 8-line format, and a number of subsequent additional-play representations of the ticket may be provided in a 1-line game format. In this example, the use of a different display structure for the subsequent additional-play representations proposes an additional incentive to players.

Furthermore, the invention discloses a system and method for the generation and storage of electronic lottery tickets using the instant data structure thereon. In consequence, a population of electronic lottery tickets corresponding to one game may be generated and stored on a permanent storage medium. This medium may be used afterward in a distribution module for the play of said game.

Finally, the invention also discloses a system and method for the distribution of these electronic lottery tickets in order to provide a seamless play environment. This gaming environment consists in a distribution module that is in communication with a plurality of player terminals. At their player terminals, the players are offered the electronic lottery game. A particular characteristic of this game resides in changes in game representation from one ticket to another.

### BRIEF DESCRIPTION OF THE DRAWINGS

These and other aspects and advantages of the present invention will become better understood in light of the following detailed description of preferred embodiments with reference to the accompanying drawings, in which:

FIG. 1 is a schematic representation of an example of an 8-line game format as used in a preferred embodiment of the invention;

FIG. 2 is a game overview according to an example of a preferred embodiment of the invention;

FIG. 3 is a schematic representation of the variable-size data structure in accordance with an embodiment of the invention;

FIG. 4 is a flow chart illustrating ticket generation process in accordance with an embodiment of the invention;

FIG. 5A is a first part of a flow chart illustrating game representation at a player terminal in accordance with an embodiment of the invention;

FIG. 5B is a second part of a flow chart illustrating game representation at a player terminal in accordance with an embodiment of the invention; and

FIG. 6 is a block diagram illustrating an arrangement comprising a player terminal and a distribution module in accordance with an embodiment of the invention.

### DETAILED DESCRIPTION OF THE INVENTION

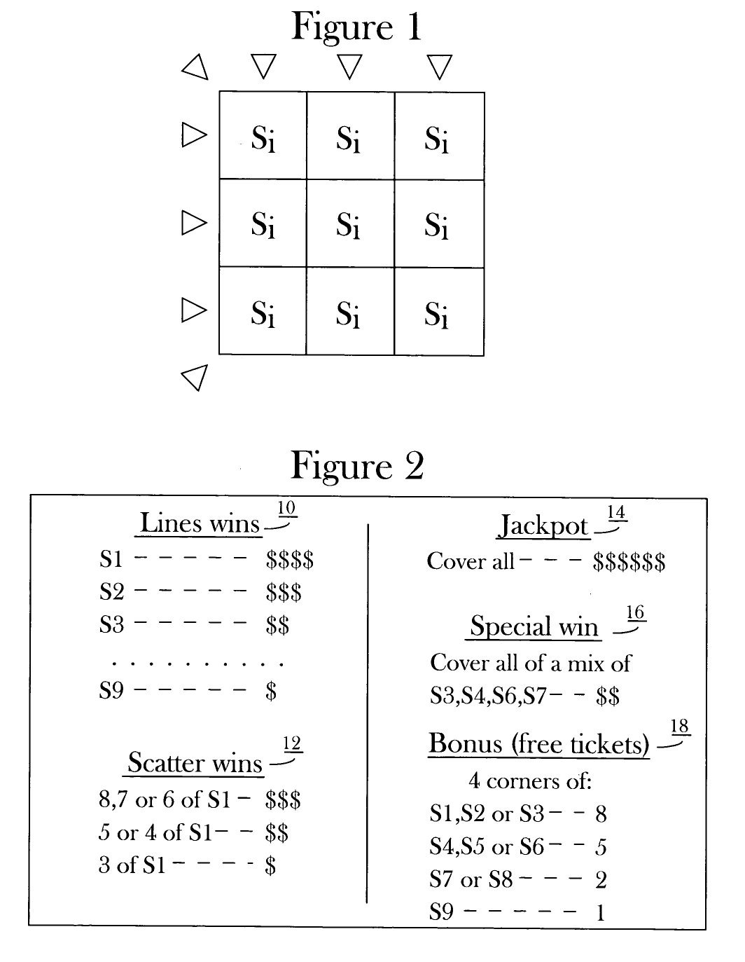

To disclose a method of using the electronic-lottery-ticket data structure, the current example uses an 8-line game format, as shown in FIG. 1. The eight lines are identified by the eight arrows in FIG. 1. In order to play the game, the player places a bet (also called a purchase fee when it is a ticket game) with the outcome value being based on said bet. With ticket games, the player usually has no control over the ticket fee required; it is fixed for the game. This game format lays in a representation of a matrix of three (3) rows by three (3) columns. A symbol (generally called game indicia) Sᵢ is displayed in all areas defined by the intersection of a column and a row. Accordingly, the total number of symbols composing an outcome of this game is nine (9). The outcome is evaluated based on different criteria, such as the symbol combination defined by a pay line (which may be a vertical, a horizontal or a diagonal line) or a combination of symbols in a predetermined non-linear configuration.

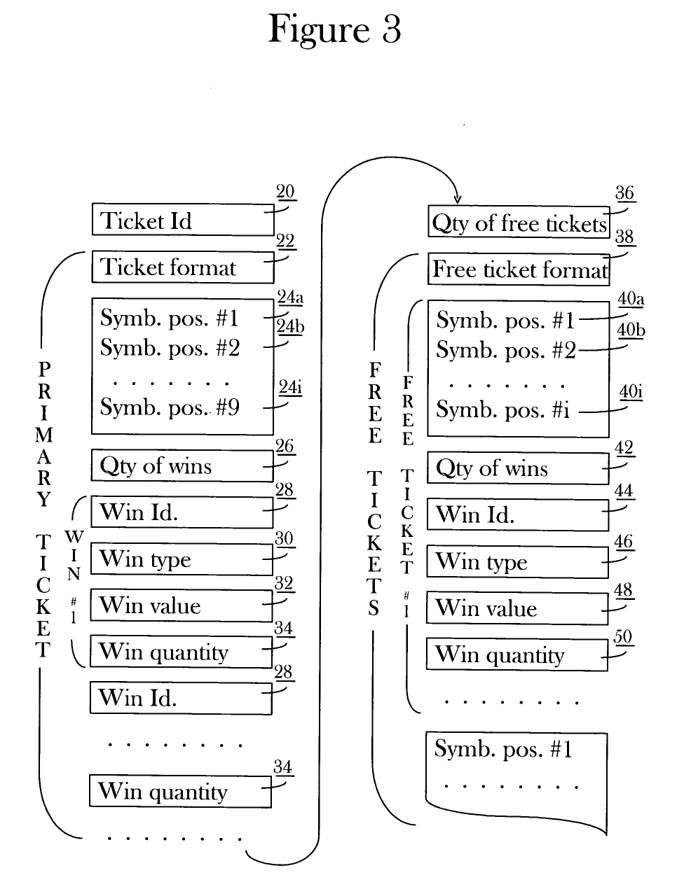

An overview of the disclosed game is shown in FIG. 2. As disclosed, a number of different prize categories and outcome criteria are available within this game: line wins 10, scattered wins 12 based on a number of a particular symbol occurrence, a jackpot win 14 based on a “cover all” of any identical symbol, multi-symbol wins 16, and free-ticket wins 18 triggered by a ticket outcome fulfilling the free-ticket criterion. The free-ticket criterion requires the presence of four (4) times the same symbol on the game matrix in a particular configuration: a symbol representation on each one of the four corner areas of the matrix. Upon occurrence of a ticket outcome fulfilling the free-ticket criterion, the player is awarded up to eight (8) free tickets of the game in the same display structure or in a different display structure. As a result, the purchase of a single ticket provides the player up to nine (9) ticket outcomes.

A ticket-generating program generates the electronic lottery tickets. The ticket-generating program uses a pay schedule divided in two parts: a primary-play pay schedule and a free-play pay schedule. The two pay schedules give all the necessary information to generate all electronic lottery tickets of the game: the game format in which the ticket outcome is displayed, the number of winning tickets provided to the player upon purchase of a single ticket, the ticket values, the ticket representation requirements, the population size of electronic lottery tickets, etc. Based on the two pay schedules, the ticket-generating program builds a population of electronic lottery tickets. Each ticket information includes all the required information for their play: the ticket value, the list of the prizes won on the ticket, the symbols participating into the ticket outcome, ticket outcome representation information, and information related to free-plays. Consequently, each single electronic lottery ticket contains all information for ticket representation on a player terminal, including primary-play representation and subsequent-play representation information related to the purchased electronic lottery ticket.

During the process of ticket generation, electronic lottery tickets are generated one at a time and stored as a game population on a ticket storage medium. The ticket storage medium is afterward inserted into ticket distribution module for its play. The quantity, therefore the size, of the ticket information stored varies from one ticket to another. Based on a ticket whether or not including free-ticket information, the quantity of information of a ticket may be limited to the information related to primary-play representation or additionally to subsequent-play representations.

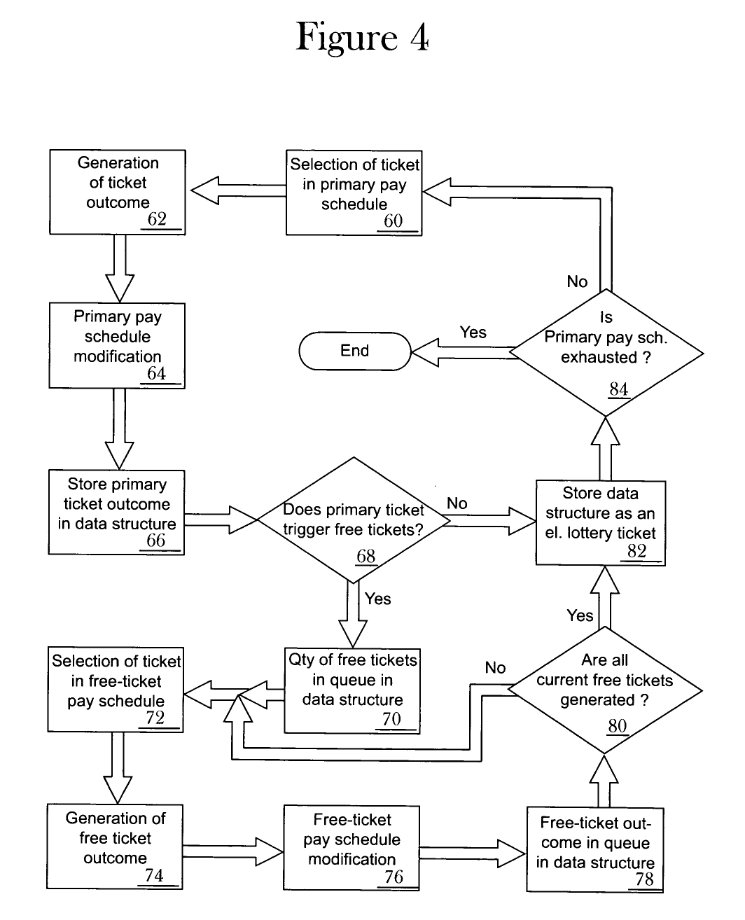

FIG. 3 provides a schematic representation of the data structure used for the generation, storage and communication of electronic lottery ticket information. The data structure organizes ticket information to include: a) a unique ticket identifier 20; b) an outcome format identifier 22, (which in this case identifies a 8-line game format); c) identification of the symbols 24a-i composing the primary-play representation of the ticket (therefore the outcome) in a predetermined order; d) the number of winning criterion met 26 by the primary-play; and a list of each winning criteria met, including for each of them: e-1) the criterion identification 28, e-2) the criterion winning type 30, e-3) the criterion win value 32, and e-4) the number of times this criterion is fulfilled by the outcome 34 since some criteria may be fulfilled more than once by a single outcome. Once all of the winning criteria that are fulfilled by the outcome are listed, additional information contained in the data structure consists in: f) identification of the number of subsequent free-plays 36 triggered by the primary-play representation. In case of no free-play being triggered by the primary-play representation, the information contained in the data structure stops there. However, in case of a positive number of subsequent free-plays, the information continues with additional information for each free-ticket characterized in: g) free-play outcome-format identifier 38; h) identification of the free-play symbols 40a-i in a predetermined order; i) number of free-play winning criteria fulfilled 42, and a list of each of free-play winning criteria fulfilled, including for each one of them: j-1) criterion identification 44, j-2) criterion winning type 46, j-3) criterion win value 48, and j-4) the number of times the criterion is fulfilled by the outcome 50.

The result of the above-described data structure is an electronic lottery ticket using a variable quantity of information. This data structure provides a more flexible game wherein a plurality of game criteria; game representations; game features and free-play tickets are available.

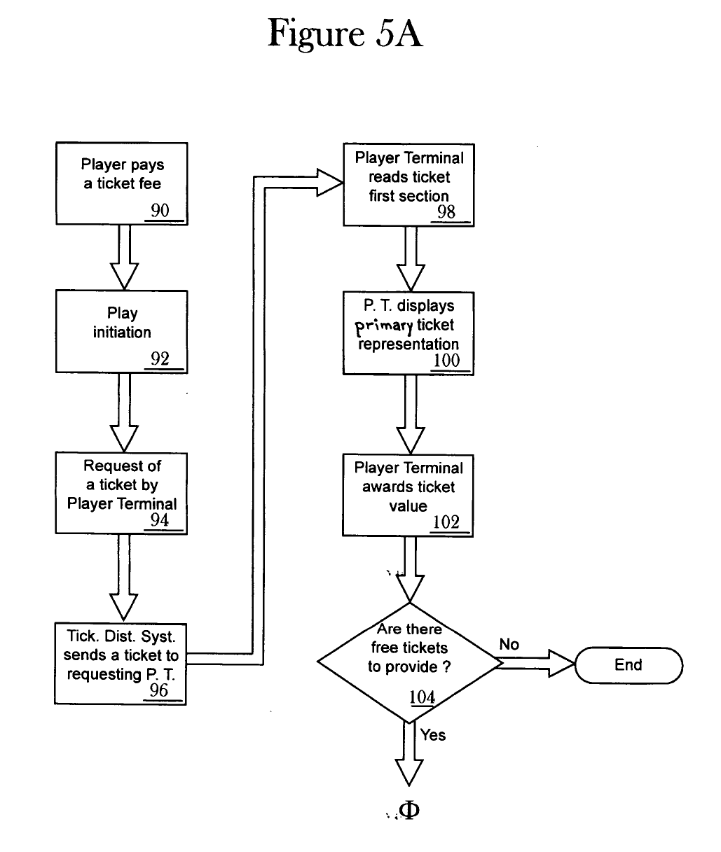

FIG. 4 schematically illustrates via a flow chart the process of the ticket generation program generating electronic-lottery-ticket information. First, a random selection 60 and generation 62 of information composing a primary ticket is completed based on a copy of the primary-pay schedule. A record corresponding to the generated primary ticket is retrieved 64 from the copy of the primary pay schedule. Information corresponding to the generated primary ticket is placed 66 in a temporary ticket data structure. Primary-ticket information is evaluated 68 based on free-play criterion. In case of a positive free-play evaluation, the number of free plays to associate to the primary-play is determined 70, and this value is stored in queue in the data structure. Then, each subsequent free-play to associate to the primary play is selected 72 and generated 74 based on a copy of the free-play pay schedule thereby modifying it 76, and the generated information is placed 78 in queue in the temporary ticket data. In the case of a negative free-play criterion evaluation, or when all free-plays have been generated and are placed 80 in queue in the temporary ticket data, the temporary ticket data is stored 82 as a game ticket on a ticket storage medium or a temporary ticket storage medium. The process continues until all primary plays are generated and stored 84, the same goes for the free plays. Then, the information is transferred on a mobile ticket storage medium that can be inserted into the ticket distribution module (if necessary).

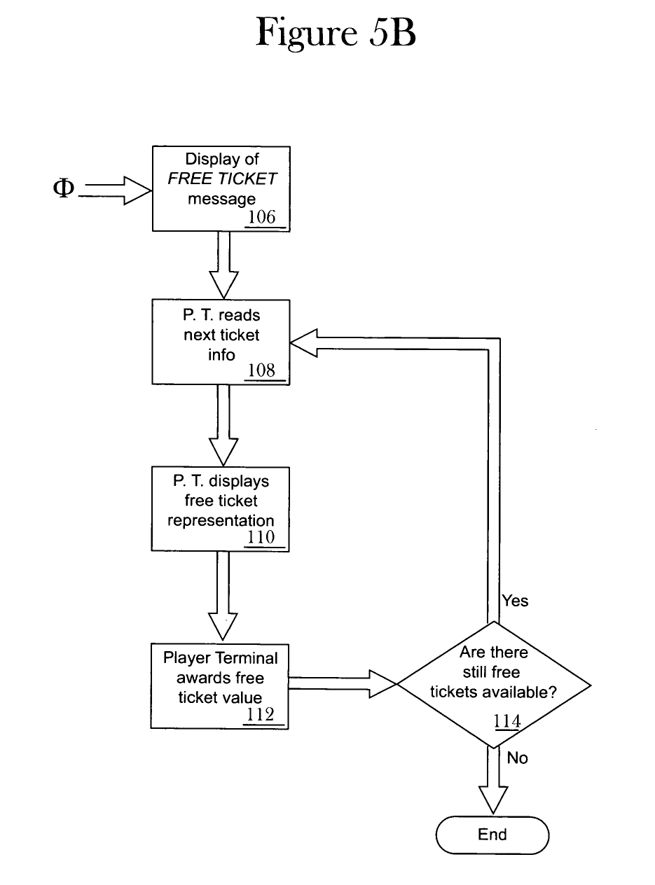

FIGS. 5A and 5B schematically illustrates the process related to the play of electronic lottery tickets on a player terminal. First, the player pays 90 a ticket fee to play the game and actuates 92 the game. As a result, the player terminal requests 94 an electronic lottery ticket of the game from the game distribution module. The game distribution module therefore sends 96 a ticket to the player terminal. The player terminal reads 98 the electronic-lottery-ticket information in its received order; consequently, the player terminal reads at least the game format to use for the play representation and the participating symbols; retrieves corresponding information (graphic and sound data for instance) from a permanent memory of the player terminal; and generates 100 a play representation to display on the player-terminal screen. Additional representation features such as highlighting of winning symbol combinations, special sounds, animations, etc are also provided based on read ticket information. The prizes won are then paid 102. When reading, at step 104, electronic-lottery-ticket information, if the information includes free-play information, a FREE TICKETS message is displayed 106 (FIG. 5B) on the player-terminal screen and the player terminal provides a play representation (108, 110 and 112) of all subsequent free-plays one at a time, including prize evaluation and awarding, until all the free-plays are finally played 114. During representation of these free plays, no communication is required between the player terminal and the ticket distribution module; the player terminal already has the necessary information for all these play representations within the original electronic-lottery-ticket information. When all representations of the electronic lottery ticket are provided on the player terminal screen, the player may purchase a new electronic lottery ticket of the game, which would cause the player terminal to send a new ticket request to the ticket distribution module.

While the invention has been disclosed based as an 8-line game using free plays as variable play representation information, the game may vary in format, in representation, or in characteristics from one electronic lottery ticket to another. For instance, free play information may elect a game format and representation differing from the principal play representation format; it may elect a different set of symbols, different criteria, different prizes, different fees, etc.

Moreover, variable primary play information may be used to modify the process of providing a representation of the primary play. For instance, the variable information may elect the play of a special animation and/or sound during the representation of the electronic lottery ticket.

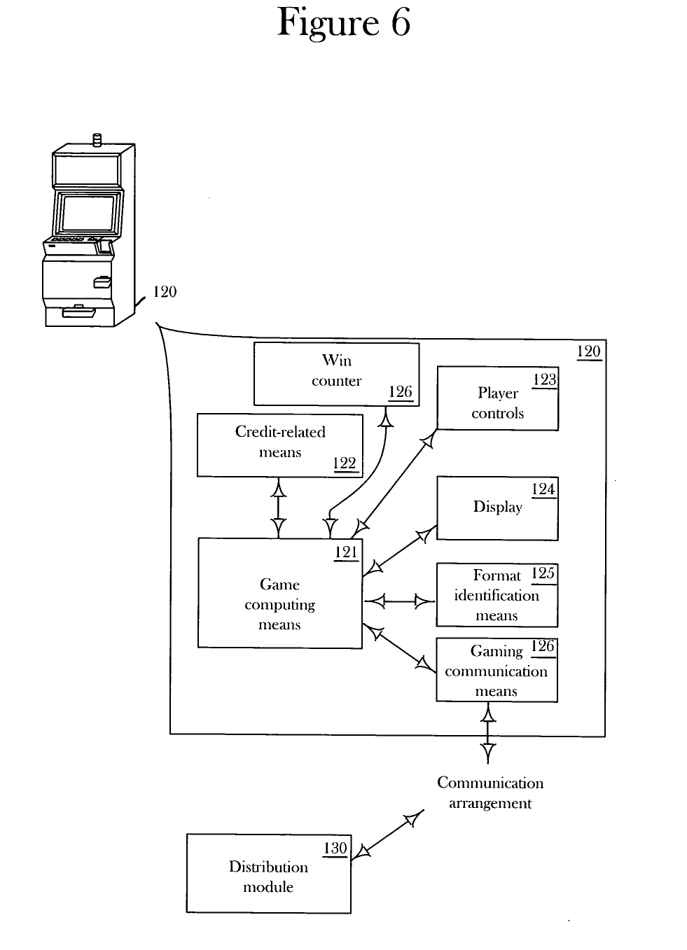

Now referring to FIG. 6, the details of an arrangement comprising a player terminal 120 and a distribution module 130 are shown. Each player terminal 120 is composed of credit-related means 122, for the insertion, handling, monitoring and redemption of players' credits; player controls 123, which allow the player to input game-related information such as game level, game title selection, redemption request, etc; a screen 124 that provides a graphic interface for player selections and graphical representation of the game; gaming computing means 121 completing game-related tasks and controls, such as card evaluation and game representation generation; and gaming communication means 126 communicating in communication with distribution module 130.

In an embodiment where the data structure is distributed on electronic player terminals for playing a game, each player terminal 120 may include a counter (win counter 126) in which the win values are accumulated during the play of a single data structure. When a representation of the whole data structure is provided to the player, the amount accumulated in the win counter 126 is transferred into the player's account.

In another embodiment, the player terminal 120 may include a format identification means 125 identifying the outcome format of a primary ticket and of one or more subsequent tickets. This identification is based on the electronic lottery ticket information and causes the player terminal 120 to modify at least one of the primary ticket format and the subsequent ticket outcome format.

Accordingly, while the invention has been described in connection with the specific embodiment thereof, it will be understood that it is capable of further modifications. It is the intend to cover any variations, uses, or adaptations of the invention following, in general, the principles of the invention and including such departures from the present disclosure as come within known or customary practice within the art to which the invention pertains. These applications will find their essential features herein set forth in the scope of the appended claims.

1. A data structure for an electronic lottery ticket used for the play of an electronic lottery game, said data structure comprising:
primary-section data providing information on an electronic-lottery-ticket play outcome; and
variable-section data providing additional information on play representation of said electronic-lottery ticket,
wherein said additional information determines electronic-lottery-ticket play representation without changing said electronic-lottery-ticket play outcome.

2. The data structure of claim 1, wherein said play representation comprises at least one of an animation, a sound, a graphic, a set of symbols and a new play representation.

3. The data structure of claim 1, further comprising subsequent play-section data, wherein subsequent play-section data comprises information on a subsequent-play representation taking place after a primary play representation, wherein subsequent play-section data information is correlated to primary-section data.

4. A data structure for an electronic lottery ticket used for the play of an electronic lottery game, said data structure comprising:
primary-section data providing information on a primary play representation; and
subsequent-section data wherein each one of said subsequent-section data provides information on one subsequent play representations, taking place after said primary play representation, and wherein at least one of said subsequent-section data is correlated to information contained in said primary-section data.

5. The data structure of claim 4, wherein primary- and subsequent-section data comprise information on electronic-lottery-ticket value.

6. The data structure of claim 4, wherein said play representation comprises information on at least one of electronic-lottery-ticket outcome format and game indicia of play representation.

7. The data structure of claim 4, wherein a single ticket purchase fee is required for the play representation of all information contained in a single data packet based on said data structure.

8. The data structure of claim 4, wherein ticket information based on said data structure is generated via a ticket generation program based on information of one a primary-play pay schedule and at least one subsequent-play pay schedule.

9. The data structure of claim 4, wherein information corresponding to at least one electronic lottery ticket is provided by a ticket distribution module to a player terminal upon request.

10. The data structure of claim 4, wherein primary-section data comprises ticket identification information.

11. A method of generating an electronic-ticket-lottery game using a population of electronic lottery tickets having a data structure, said method comprising:
establishing primary play information to generate based on a primary-play pay schedule;
generating primary-section data comprising said play information and placing said primary-section data in said data structure, said primary-section data including at least a primary-play ticket value;
establishing variable information data for modifying electronic-lottery-ticket play representation and placing said variable information data in said data structure; and
storing said data structure on a storage medium.

12. The method of claim 11, wherein said establishing comprises determining said variable information data for modifying said play representation by at least one of an animation, a sound, a graphic, a set of symbols and a new play representation.

13. The method of claim 11, further comprising establishing subsequent play-section data, wherein subsequent play-section data provides information on a subsequent-play representation taking place after a primary play representation, wherein subsequent play-section data information is correlated to primary-section data.

14. A method of generating an electronic-ticket-lottery game using a population of electronic lottery tickets having a data structure, said method comprising:
establishing primary play information to generate based on a primary-play pay schedule;
generating primary-section data comprising said primary play information and placing said primary-section data in said data structure, said primary-section data including at least a primary-play ticket value;
establishing, in correlation to said primary-section data, subsequent-play data to be generated;
for each subsequent-play data:
establishing subsequent play information to generate based on a subsequent-play pay schedule;
generating a subsequent-section data comprising said play information; and
placing said subsequent-section data in said data structure, said subsequent-section data including at least a subsequent-play value; and
storing said data structure on a ticket storage medium.

15. The method of claim 14, further comprising repeating steps of claim 14 until all tickets corresponding to said primary-play pay schedule have been generated and stored on said ticket storage medium, wherein the total amount of stored data structures composes the complete population of electronic lottery tickets of said game.

16. The method of claim 15, further comprising communicating said population to a ticket distribution module for electronic-lottery-ticket consumption.

17. The method of claim 14, wherein primary- and subsequent-section data comprise information on play representation.

18. The method of claim 14, wherein primary- and subsequent-section data comprise information on at least one of play representation format and.

19. The method of claim 14, wherein primary-section data comprises electronic-lottery-ticket primary-play purchase fee information.

20. The method of claim 19, wherein subsequent-section data comprises electronic-lottery-ticket subsequent-play purchase fee information differing from said primary-play purchase fee information.

21. A method of playing an electronic-lottery-ticket game involving consumption of electronic lottery tickets having information comprising primary-section data and variable information data for modifying electronic-lottery-ticket play representation, said method comprising:
receiving a ticket purchase fee from a player;
consuming at least one of said electronic lottery ticket in response to said fee receipt, wherein said consuming comprises:
identifying, within said information contained in said electronic lottery ticket, said primary-section data;
identifying, within said information contained in said electronic lottery ticket, said variable information data;
identifying characteristics of said play representation in correlation with said variable information-data; and
providing said play representation based on said primary-section data and said play characteristics, wherein an outcome is independent of said play characteristics; and
awarding a prize according to said outcome.

22. A method of playing an electronic-lottery-ticket game involving consumption of electronic lottery tickets having information comprising primary-section data and subsequent-section data for modifying electronic-lottery-ticket play representation, said method comprising:
receiving a ticket purchase fee from a player;
consuming at least one of said electronic lottery ticket in response to said fee receipt, said consuming comprising:
identifying, within said information contained in said electronic lottery ticket, said primary-section data;
providing a primary play representation of a primary ticket based on primary-section data;
identifying, within said information contained in said electronic lottery ticket, said subsequent-section data; and
for each subsequent-section data, providing a subsequent play representation of a subsequent ticket based on said subsequent-section data; and
awarding a prize according to said electronic lottery ticket.

23. The method of claim 22, further comprising:
requesting an electronic lottery ticket from a ticket distribution module; and
obtaining, upon said request, said electronic lottery ticket from said ticket distribution system.

24. The method of claim 22, further comprising:
crediting said player primary-ticket value in a win counter;
for each subsequent-section data, taking a subsequent-ticket purchase fee from said win counter and crediting said player subsequent-ticket value in said win counter; and
when a representation of all of the primary ticket and the subsequent tickets have been provided, using available credits in said win counter to award a prize to said player.

25. The method of claim 22, wherein comprises performing said consuming step on a player terminal.

26. The method of claim 25, comprising storing said electronic lottery tickets on a ticket distribution module and wherein said ticket distribution system provides said electronic lottery ticket upon request from said player terminal.

27. The method of claim 22, wherein an outcome format of said primary ticket differs from an outcome format of said subsequent ticket.

28. A player terminal adapted for playing a lottery game involving the use of electronic lottery tickets of variable information-size, said player terminal comprising:
a communication arrangement for receiving said electronic lottery tickets; and
a play control arrangement for:
causing the player terminal to request an electronic lottery ticket to the electronic lottery ticket storage medium and to receive it from the electronic lottery ticket storage medium;
causing the player terminal to display a primary ticket representation upon reading of the electronic lottery ticket;
causing the player terminal to identify a number of subsequent tickets associated with said primary ticket and identifying representations of said subsequent ticket based on the electronic lottery ticket information;
causing the player terminal to display, one at a time, said subsequent ticket representations; and
causing the player terminal to award a prize to the player according to the electronic lottery ticket played.

29. The player terminal of claim 28, further comprising a fee-receiving device to receive ticket purchase fees.

30 The player terminal of claim 29, further comprising a win counter recording credited prizes of a single ticket and withdrawing of subsequent ticket purchase fees.

31. The player terminal of claim 28, wherein said player terminal further comprises a format identification means identifying primary ticket outcome format and a subsequent ticket outcome format based on the electronic lottery ticket information and causing the player terminal to modify at least one of said primary ticket format and said subsequent ticket outcome format.

32. The player terminal of claim 28, wherein said ticket representations are provided on an electronic display.

33. The player terminal of claim 28, wherein said electronic lottery tickets are stored on an electronic lottery ticket storage medium remote from said player terminal.

34. A data structure for an electronic lottery ticket used for the play of an electronic lottery game, said data structure comprising:
a primary-section data of a fixed-size providing information on a primary ticket; and
subsequent-section data wherein each one of said subsequent-section data provides information on modification of said electronic lottery ticket play.

35. The data structure of claim 34, wherein said modification of electronic lottery ticket play comprises:
providing information on ticket representation to be provided after representation of a ticket corresponding to primary-section data;
providing information on game modification to be provided during representation of a ticket corresponding to primary-section data;
providing information on player-selection option to be offered after representation of a ticket corresponding to primary-section data; and
providing information on additional representation differing presentation of current ticket from presentation of at least one other ticket representation.

36. The data structure of claim 35, wherein said additional representation comprises an animation played during representation of said ticket.

37. The data structure of claim 34, wherein said subsequent-section data comprises an association to a prize value.

38. The data structure of claim 34, wherein said primary-section data includes unique ticket identification.
